(19) United States
(12) Patent Application Publication
(10) Pub. No.: US 2003/0147252 A1
(43) Pub. Date: Aug. 7, 2003

(54) Front lighting system for a motor vehicle

(75) Inventor: Matteo Fioravanti, Moncalieri (IT)

Correspondence Address: SUGHRUE MION, PLLC, 2100 PENNSYLVANIA AVENUE, N.W., WASHINGTON, DC, 20037, US

(73) Assignee: FIORAVANTI S.R.L.

(21) Appl. No.: 10/355,288

(22) Filed: Jan. 31, 2003

(30) Foreign Application Priority Data
Feb. 6, 2002 (IT) T02002A000103

(51) Int. Cl. B60Q 3/04

(52) U.S. Cl. 362/543; 362/544

(57) ABSTRACT

The system comprises a pair of optical assemblies, left and right respectively, each including a support base on which a plurality of optical elements are mounted, and a transparent cover for protecting the optical elements and being passed through by the light emitted by these latter. Each optical element includes a LED light source controllable by a remote control unit and is intended to carry out one function from the group comprising position light, dipped-beam headlight, main-beam headlight, fog headlight and turn indicator light. By virtue of the use of LED optical elements, it is possible to provide optical assemblies of small sizes, the shape of which can be adapted easily to that of the vehicle body.

### BACKGROUND OF THE INVENTION

The present invention relates to a front lighting system for a motor vehicle, intended to function as position light, dipped-beam headlight, main-beam headlight, fog headlight and turn indicator light.

According to traditional motor-vehicle front lighting systems, lights are used for carrying out the functions of position signaling and turn indication, whereas headlamp or headlights are used for carrying out the functions of driving or main-beam lighting, of crossing or dipped-beam lighting and of fog lighting.

In order to comply with the photometric characteristics prescribed by regulations in different countries, there are commonly used optical assemblies such as reflector paraboloids or systems of prisms and lenses formed in the transparent element of the light or headlamp, which is normally made of a transparent synthetic resin. A one or two-filament incandescent lamp or a halogen lamp, such as an iodine lamp, are normally used as light source.

Recently, the use of xenon headlights has started to gain ground. These headlights are provided with lamps having no metal filament, with a pair of electrodes immersed in a xenon atmosphere and connected to the two poles of an electrical circuit. The discharge of electrons between the two electrodes is able to produce a very intense light, about twice the intensity of that of halogen lamps, which is also extremely white. Since there is no filament, these lamps last longer (around twice the time) and use less energy (around 70% less) than conventional lamps. These lamps are controlled by a pair of electronic control units, one for overall operation control and the other for supply voltage setting. Normally used for main-beam headlights, xenon lamps are starting to be used for dipped-beam headlights as well. However, although they give a better performance than conventional lamps, xenon lamps have the disadvantage of being somewhat more expensive and of requiring a high-power electronic unit for converting direct current into alternating current at a voltage of around 20,000 V, which is needed for ignition of the gas.

### SUMMARY OF THE INVENTION

The object of the present invention is to provide a system for the front lighting of a means of transport, in particular a motor vehicle, which is innovative compared to the prior art discussed above.

This object is fully achieved, according to the present invention, by virtue of a lighting system having the characteristics defined in claim 1. Further advantageous characteristics are defined in dependent claims.

In summary, the invention is based on the principle of providing a front lighting system for a motor vehicle comprising optical elements which use light emitting diodes or LEDs as light source, the LEDs being selectively controllable by a remote electronic unit to operate as position lights, dipped-beam headlights, main-beam headlights, fog headlights or turn indicators. The system is designed as a cluster of elementary units each intended to carry out one of the aforesaid functions, wherein the arrangement of the units is advantageously set in order to achieve a particular aesthetic effect.

The solution suggested here preferably makes use of latest generation LEDs, able to provide a luminous intensity of around 50 lumen of white light, compared to the 20 lumen provided by LEDs of conventional type. The use of high-power LEDs enables to achieve ,the required lighting power with a smaller number of light sources, thereby taking up less space and complying with the space restrictions imposed by the manufacturers of the vehicles into which the optical assemblies are to be fitted.

The use of a LED construction, intended as the sum of specific elementary functions which can be used as a whole, in part or one by one, enables to concentrate all the lighting functions of the motor vehicle, including those of turn indicator and fog headlight, into one optical assembly.

The structure of these optical assemblies offers several advantages over those of the prior art, namely they take up less space and offer more flexibility as to their spatial arrangement at the front of the vehicle, whereby the aerodynamics of the vehicle can be optimized.

The use of LEDs as light sources also enables to reduce the energy consumption and to increase the life of the optical assemblies compared to those of the prior art operating with incandescent or iodine lamps, and also to cut manufacturing costs compared to optical assemblies operating with xenon lamps.

### BRIEF DESCRIPTION OF THE DRAWINGS

The characteristics and the advantages of the present invention will become more apparent in the light of the detailed description which follows, provided purely by way of non-limitative example, with reference to the appended drawings, in which:

FIG. 1 is a front perspective view schematically illustrating a front left optical assembly for a motor vehicle according to a preferred embodiment of the invention;

FIG. 2 is a vertical longitudinal section of the optical assembly of FIG. 1; and

FIG. 3 is a vertical longitudinal section of a single LED optical element of the optical assembly of FIG. 1.

### DETAILED DESCRIPTION OF THE PREFERRED EMBODIMENT

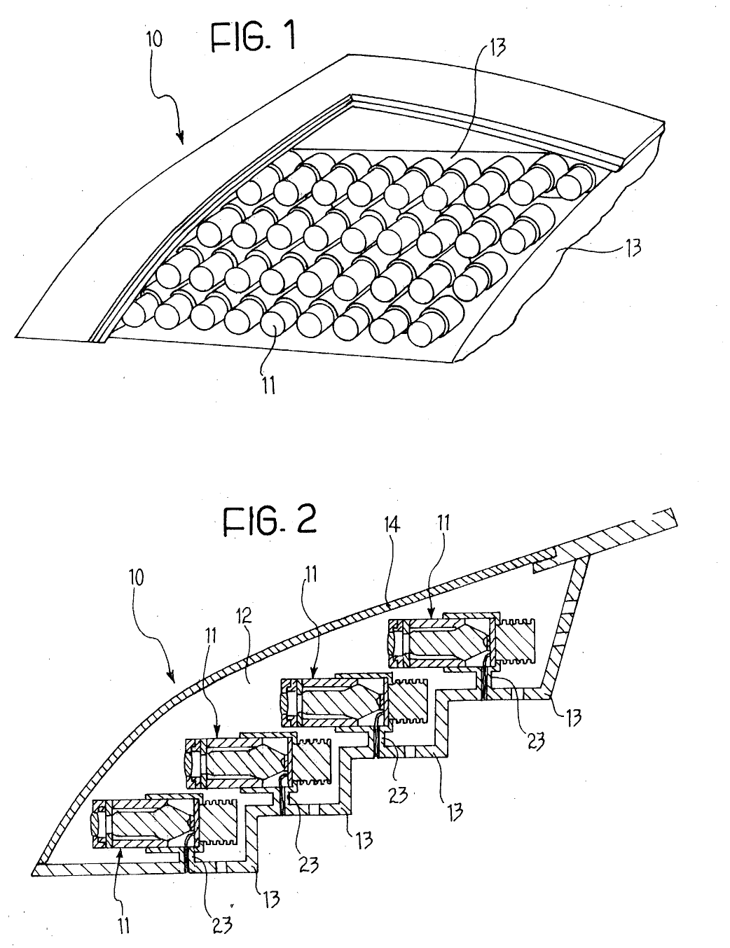

As shown in FIGS. 1 and 2, an optical assembly according to the present invention, generally indicated 10, includes a plurality of optical elements 11 arranged in an orderly layout inside a space 12 defined between a support base 13 and a transparent cover 14. The elements 11 are organized in units each intended to carry out one elementary function (position light, main-beam headlight, dipped-beam headlight, turn indicator or fog headlight). Elements 11 belonging to the same functional unit can be either grouped together or spread out in different ways inside the optical assembly 10 so as to produce a particular aesthetic effect, while still complying with regulations laid down in different countries.

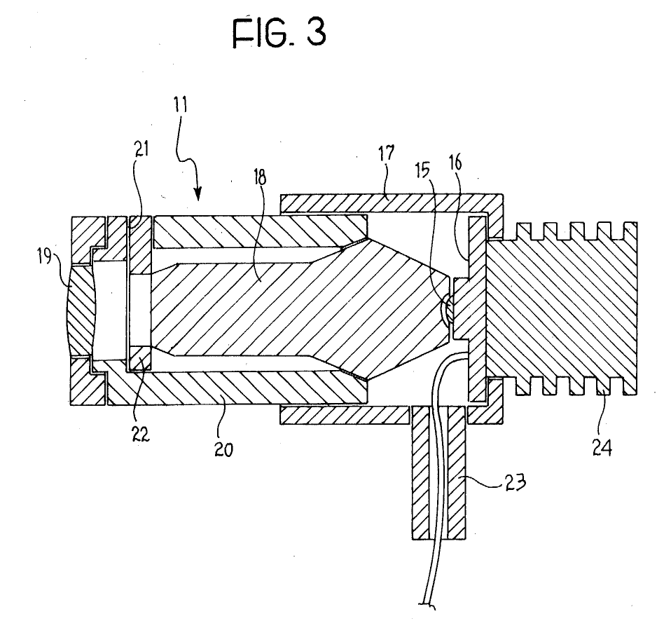

By referring now to the embodiment illustrated by way of example in FIG. 3, each optical element 11 includes a LED light source 15, advantageously of the high-power type mentioned above, mounted on a support plate 16 fixed to the bottom of a cup-shaped element 17. An optical guide 18 is associated with the light source 15 for guiding the light emitted by the source towards a lens 19 mounted on a hollow cylindrical element 20 coaxial with the cup-shaped element 17.

The cylindrical element 20 is first inserted axially slidable in the cup-shaped element 17, whereby the distance between the LED 15 and the lens 19 can be adjusted in accordance with the operating specifications required for that particular optical element, and is then fixed to the cup-shaped element 17, for example by gluing.

Should the optical element be intended to operate as a main-beam headlight, a transverse slit 21 is formed in the cylindrical element 20 and a diaphragm 22 is inserted therein for giving the light emitted a typical asymmetrical orientation, as prescribed by current regulations.

The optical element 11 is mounted on the support base 13 by means of a column 23, inside which the electrical connections for the power supply to the LED are housed.

In order to disperse the thermal power dissipated by the LED, which is in any case far less than that dissipated by an ordinary incandescent lamp, cooling fins 24 are provided behind the bottom of the cup-shaped element 17 and are connected to the support plate 16 of the LED.

Each optical element 11 has a lens and an optical guide, both being adapted to the function to be carried out (position light, dipped-beam headlight, main-beam headlight, turn indicator or fog headlight).

In the event of LED light sources being used which are able to provide a luminous intensity of around 50 lumen of white light, each function, be it position light, main-beam headlight, dipped-beam headlight or fog headlight, will require at least ten optical elements (generally from ten to sixteen 16), whereas the turn indicator function will require at least two elements (generally from two to five). If and when LED technology makes LEDs available which provide 150 or more lumen of luminous intensity, then it will be possible to reduce proportionally the number of optical elements required for each function, thus further reducing the sizes of an optical assembly according to the invention.

Advantageously, each of the optical elements is controlled individually by the electronic control unit in order to carry out the function assigned thereto. This peculiarity also enables to carry out a range of auxiliary functions, such as controlling the orientation and instant luminosity of the light beam emitted by each optical unit according to visibility conditions and to the speed and direction of the vehicle.

The fog headlight function is preferably incorporated into the same optical assembly intended to carry out all the other functions, but it could, without prejudice, be assigned to a separate optical assembly, should there be limited space available on the front of the vehicle.

Naturally, the principle of the invention remaining unchanged, embodiments and manufacturing details can be varied widely from those described and illustrated purely by way of non-limitative example.

What is claimed is:

1. A front lighting system for a means of transport, such as a motor vehicle, intended to carry out the functions of position light, dipped-beam headlight, main-beam headlight, fog headlight and turn indicator light, wherein the system comprises a plurality of optical elements, each including a LED light source controllable by a remote electronic control unit and guide means for guiding the light beam emitted by the LED light source.

2. The front lighting system of claim 1, wherein each of the said optical elements is arranged to carry out one function from the group comprising position light, dipped-beam headlight, main-beam headlight, fog headlight and turn indicator.

3. The front lighting system of claim 1, wherein the optical elements are organized into elementary functional units, each operable to carry out one of the aforesaid functions and which can be used either as a whole or as selectively operable sub-units.

4. The front lighting system of claim 1, wherein the optical elements are organized into elementary functional units, each operable to carry out one of the aforesaid functions and which can be used either as a whole or as selectively operable sub-units, and wherein the remote control unit is arranged to control the said elementary functional units in dependence on control parameters such as the visibility and the speed and direction of the vehicle.

5. The front lighting system of claim 1, wherein it comprises a pair of optical assemblies, left and right respectively, each including a support base on which the respective optical elements are mounted and a transparent cover for protecting the optical elements and being passed through by the light emitted by these latter.
